(19) United States
(12) Patent Application Publication
(10) Pub. No.: US 2009/0063129 A1
(43) Pub. Date: Mar. 5, 2009

(54) METHOD AND SYSTEM FOR INSTANTLY TRANSLATING TEXT WITHIN IMAGE

(75) Inventors: Tony Tsai, Taipei (TW); Liang Huang, Shanghai City (CN); Yan Jin, Shanghai City (CN)

Correspondence Address: J C PATENTS, INC., 4 VENTURE, SUITE 250, IRVINE, CA, 92618, US

(73) Assignee: INVENTEC APPLIANCES CORP., Taipei (TW)

(21) Appl. No.: 12/201,243

(22) Filed: Aug. 29, 2008

(30) Foreign Application Priority Data
Aug. 29, 2007 (TW) 96132004

(51) Int. Cl. G06F 17/28

(52) U.S. Cl. 704/3

(57) ABSTRACT

A method and a system for instantly translating text within an image are provided. The method and the system are suitable for using a service end device to translate text within the image captured by a portable communication device. First, the image is captured by the portable communication device, and then transmitted to the service end device through a communication network. Next, the text within the image is recognized and translated into translation text by the service end device. The translation text is transmitted back to the portable communication device through the communication network and displayed by the portable communication device. Thereby, a user can take an image at any time and get to know what it means immediately.

### CROSS-REFERENCE TO RELATED APPLICATION

This application claims the priority benefit of Taiwan application serial no. 96132004, filed on Aug. 29, 2007. The entirety of the above-mentioned patent application is hereby incorporated by reference herein and made a part of specification.

### BACKGROUND OF THE INVENTION

1. Field of the Invention

The present invention generally relates to a method for translating text within an image, and more particularly, to a method for instantly translating text within an image remotely captured by a portable communication device.

2. Description of Related Art

Along with the development of electronics technology, every consumer electronic product in the market is integrated with multiple functions in order to improve the competitiveness thereof. Besides the standard functions such as photographing, voice communication, and internet access, a translation function is further integrated into various portable communication devices, such as mobile phones or personal digital assistants (PDA). Besides, the means for inputting text of a conventional translator is changed from keypad input to hand writing or voice input, etc. To use a conventional translator, a user has to understand the characters or pronunciation of the text to be translated and inputs the text through an appropriate input method or a microphone. However, the conventional translator becomes useless when the user encounters text of an unfamiliar language. For example, when a user goes aboard for a business trip or a vacation, since he cannot understand the text, he is not able to input any text he encounters into the conventional translator.

Thereby, some manufactures integrate optical character recognition (OCR) technique into portable electronic devices so that the text within an image taken by a digital camera can be recognized by the OCR and then translated. Accordingly, the text can be translated even though the user does not know the language. However, in the current trend of minimizing the weights and sizes of electronic products, the storage capacity of a portable communication device is limited and accordingly the expansion of database is restricted. As a result, the OCR cannot work efficiently. Even though a conventional portable communication device can only translate some simple text, for some special or complicated text, such as text containing multiple languages, irregularly-edited text, or mega data text, the conventional portable communication device may not be able to translate such text precisely and completely, or even cannot translate it at all if the database built therein does not support the language.

### SUMMARY OF THE INVENTION

Accordingly, the present invention is directed to a system for instantly translating text within an image, in which an image captured by a portable communication device is transmitted to a service end device for recognition and translation so that the cost for disposing a translation module in the portable communication device can be saved.

The present invention is directed to a method for instantly translating text within an image, in which a complete translation function is provided based on the powerful calculation capability and storage resource of a service end device so that any image captured by a portable communication device can be instantly recognized and translated.

The present invention provides a method for instantly translating text within an image. The method is suitable for translating text within the image captured by a portable communication device. The method includes following steps. First, the image is captured by the portable communication device and then transmitted to a service end device through a communication network. Next, the text within the image is recognized and translated into translation text by the service end device, and the translation text is transmitted back to the portable communication device through the communication network, such that the translation text can be displayed by the portable communication device.

According to an embodiment of the present invention, the step of recognizing and translating the text within the image into the translation text and transmitting the translation text back to the portable communication device through the communication network by the service end device further includes instantly transmitting a portion of the translation text back to the portable communication device through the communication network when the service end device finishes translating a portion of the text within the image corresponding to the portion of the translation text. In particular, if the image comprises irregularly-edited text or mega data text, the service end device translates the portion of the text within the image and transmits the portion of the translation text back to the portable communication device instantly.

According to an embodiment of the present invention, before the service end device transmits the translation text back to the portable communication device through the communication network, a language translating request is received by the portable communication device and transmitted to the service end device through the communication network. Then, the recognized text within the image is translated by the service end device according to the language translating request.

The present invention provides a method for instantly translating text within an image. The method is suitable for translating text within the image captured by a portable communication device. The method includes following steps. First, the image is captured by the portable communication device and then transmitted to a service end device through a communication network. Next, the text within the image is recognized and translated into translation text by the service end device, and the translation text is stored into a webpage of the service end device. After that, the portable communication device can connect to the service end device and browse the translation text from the webpage by using a browser.

According to an embodiment of the present invention, the step of the service end device recognizing and translating the text within the image into the translation text and storing the translation text into a webpage of the service end device includes instantly storing a portion of the translation text into the webpage when the service end device finishes translating a portion of the text within the image corresponding to the portion of the translation text, for the portable communication device to instantly connect to the service end device and browse the translation text from the webpage.

The present invention provides a system for instantly translating text within an image. The system includes a portable communication device and a service end device. The portable communication device includes an image capturing unit and a first communication module. The image capturing unit captures the image. The first communication module transmits the image through a communication network. The service end device includes a second communication module, a text recognition module, and a translation module. The second communication module receives the image through the communication network. The text recognition module recognizes the text within the image. The translation module translates the text within the image into translation text. After the text within the image is translated into the translation text, the service end device transmits the translation text back to the portable communication device through the second communication module.

According to an embodiment of the present invention, the portable communication device further includes an input interface for receiving a language translating request. The language translating request is transmitted to the service end device through the first communication module, and the service end device translates the text within the image according to the language translating request. In addition, the service end device further includes a multi-language database for storing multiple languages, in which the translation module translates the text within the image by referring to the multi-language database.

According to an embodiment of the present invention, the text recognition module includes an optical character recognition (OCR). The portable communication device may be a mobile phone, a personal digital assistant (PDA), or a smart phone. The communication network may be a global system for mobile communication (GSM), a code division multiple access (CDMA) system, or a personal handy-phone system (PHS). The image capturing unit may be a charge-coupled device (CCD) camera or a complementary metal oxide semiconductor (CMOS) camera.

In the present invention, an image captured by a portable communication device is recognized and translated by adopting powerful calculation function and storage resource of a service end device and the translation text is then transmitted back to the portable communication device to be displayed. Thereby, the purpose of instantly translating text within an image is achieved. Moreover, for complicated text, a portion of the text within the image is transmitted back to the portable communication device once the translation of this portion of the text is finished. Accordingly, a complete, accurate, and instant multi-language translation function is provided by the present invention, and the cost for disposing a translation module in a portable communication device can be saved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a system for instantly translating text within an image according to an embodiment of the present invention.

FIG. 2 is a block diagram of a system for instantly translating text within an image according to another embodiment of the present invention.

FIG. 3 is a flowchart illustrating a method for instantly translating text within an image according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A text translation function has been integrated into existing mobile phones in the market. However, due to the limitation in the storage capacity of mobile phones, there are many restrictions in the application of the text translation function. For example, the number of languages that can be recognized and translated is limited, and the calculation for image recognition is also limited by hardware efficiency. Accordingly, a method and a system for instantly translating text within an image are provided by the present invention, in which a complete image recognition and translation mechanism is established in a service end device such that the text within an image transmitted by a portable communication device can be instantly recognized and translated. Embodiments of the present invention will be described in detail with reference to accompanying drawings.

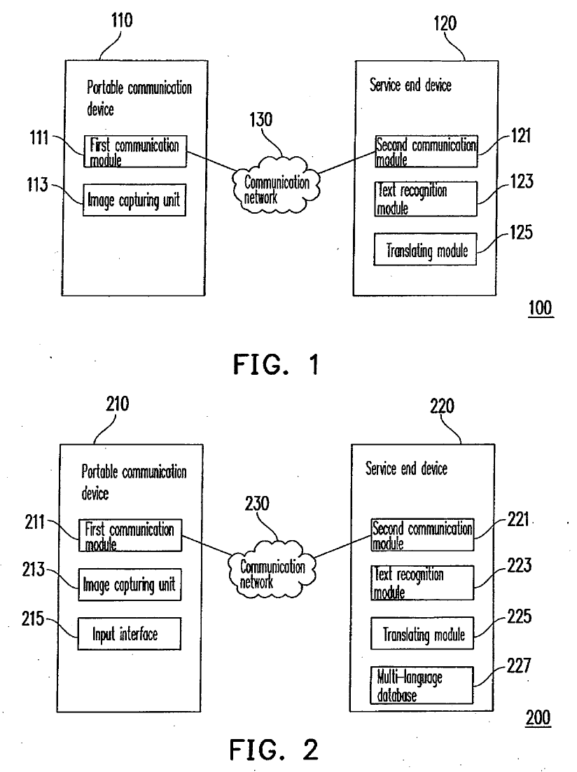

FIG. 1 is a block diagram of a system for instantly translating text within an image according to an embodiment of the present invention. Referring to FIG. 1, the system 100 includes a portable communication device 110 and a service end device 120. The portable communication device 110 includes a first communication module 111 and an image capturing unit 113. The service end device 120 includes a second communication module 121, a text recognition module 123, and a translation module 125.

The portable communication device 110 captures an image and transmits the image to the service end device 120 through a communication network 130. In the present embodiment, the portable communication device 110 may be a mobile phone, a personal digital assistant (PDA), or a smart phone. The communication network 130 may be a global system for mobile communication (GSM), a code division multiple access (CDMA) system, or a personal handy-phone system (PHS). Taking a mobile phone using GSM system as an example, the mobile phone transmits the image to the service end device 120 through the GSM system. The functions of foregoing elements will be described in detail below.

In the portable communication device 110, the image capturing unit 113 is used for capturing the image. The image capturing unit 113 may be a charge-coupled device (CCD) camera or a complementary metal oxide semiconductor (CMOS) camera. The first communication module 111 transmits the image captured by the image capturing unit 113 through the communication network 130.

On the other hand, in the service end device 120, the second communication module 121 is used for receiving the image transmitted by the first communication module 111 of the portable communication device 110 through the communication network 130. The text recognition module 123 (for example, an optical character recognition module) recognizes the text within the image. The translation module 125 translates the text within the image into translation text. Besides, a multi-language database (not shown) may be disposed in the translation module 125 so that the translation module 125 can translate the text within the image by referring to the multi-language database; however, the present invention is not limited thereto.

As a whole, after the image capturing unit 113 captures the image, the portable communication device 110 transmits the image to the service end device 120 through the first communication module 111. When the service end device 120 recognizes the text within the image through the text recognition module 123, it translates the text within the image through the translation module 125. After that, service end device 120 transmits the translation text back to the portable communication device 110 through the second communication module 121.

In an actual application, the system 100 may further include other elements to provide a more complete service to the user, which is described below with reference to another embodiment of the present invention. FIG. 2 is a block diagram of a system for instantly translating text within an image according to another embodiment of the present invention. Referring to FIG. 2, the system 200 includes a portable communication device 210 and a service end device 220. The portable communication device 210 includes a first communication module 211, an image capturing unit 213, and an input interface 215. The service end device 220 includes a second communication module 221, a text recognition module 223, a translation module 225, and a multi-language database 227.

The first communication module 211 and the image capturing unit 213 in the portable communication device 210 have the same or similar functions as the first communication module 111 and the image capturing unit 113 described in foregoing embodiment. In addition, the second communication module 221, the text recognition module 223, and the translation module 225 in the service end device 220 also have the same or similar functions as the second communication module 121, the text recognition module 123, and the translation module 125 described in foregoing embodiment. Thus, the detailed functions of these elements will not be described herein. However, in the present embodiment, the portable communication device 210 further includes the input interface 215, and the service end device 220 further includes the multi-language database 227.

In the present embodiment, the input interface 215 (for example, a keypad, a hand-writing panel, or a microphone, etc.) of the portable communication device 210 receives a language translating request input by a user, in which the language translating request is transmitted to the service end device 220 through the first communication module 211 so that the service end device 220 can translate the text within an image according to the language translating request. For example, the language translating request requests that the text within the image is to be translated into English or a language of another country; however, the scope of the language translating request is not limited in the present embodiment. Because there is no limitation in hardware expansion of the service end device 220, more language options can be provided by disposing the multi-language database 227 in the service end device 220.

To be specific, after the image capturing unit 213 captures the image, the portable communication device 210 transmits the image to the service end device 220 through the first communication module 211. Besides, the portable communication device 210 further transmits the language translating request received by the input interface 215 to the service end device 220 through the first communication module 211. After recognizing the image through the text recognition module 223, the service end device 220 translates the recognized text through the translation module 225 according to the language translating request. After that, the service end device 220 transmits the translation text to the portable communication device 210 through the second communication module 221.

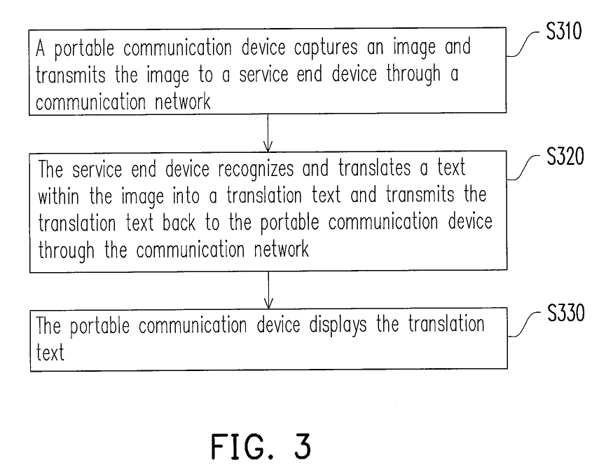

The present invention further provides a method for instantly translating text within an image along with foregoing system. FIG. 3 is a flowchart illustrating a method for instantly translating text within an image according to an embodiment of the present invention. Referring to both FIG. 2 and FIG. 3, first, in step S310, the portable communication device 210 captures the image and transmits the image to the service end device 220 through a communication network 230. To be specific, the portable communication device 210 captures the image by using the image capturing unit 213 and transmits the image to the service end device 220 through the communication network 230 by using the first communication module 211.

Taking a mobile phone using GSM system as an example, when a user of the mobile phone encounters unknown text, the user can take a photo of this text by using the mobile phone and transmit the image to the service end device 220 for translation through the GSM system. In addition, the user may further input a language translating request through the keypad (i.e., the input interface 215) of the mobile phone so that the service end device 220 can translate the text within the image according to the language translating request. For example, the user may request for translating the text within the image into English by pressing the key “1” and request for translating it into Chinese by pressing the key “2”, and so on. However, foregoing situations are only examples of the present invention but not for limiting the scope of the application thereof.

Next, in step S320, the service end device 220 recognizes the text within the image and translates it into translation text. After that, the service end device 220 transmits the translation text back to the portable communication device 210 through the communication network 230. To be specific, the service end device 220 receives the image through the second communication module 221 and then recognizes the text within the image through the text recognition module 223. Thereafter, the translation module 225 translates the text recognized by the text recognition module 223 into the translation text according to the language translating request.

It should be mentioned that the service end device 220 can instantly transmit a portion of the translation text to the portable communication device 210 through the communication network 230 when it finishes translating a portion of the text within the image corresponding to the portion of the translation text. Especially for irregularly-edited text or mega data text, it may take a long time to recognize and translate the text. In this case, the service end device 220 transmits the translated portions of the text to the portable communication device 210 for display instead of waiting for the entire text to be translated by translation module 225. As a result, the purpose of instantly translating text within an image is accomplished.

Additionally, the portable communication device 210 may inspect the translation text through different methods after the service end device 220 transmits the translation text back to the portable communication device 210. For example, the service end device 220 can transmit the translation text by using a short message, and the user can receive the translation text through a SMS function of the portable communication device 210. In addition, the service end device 220 can store the translation text into a webpage thereof and the user can connect to the webpage of the service end device 220 and browse the translation text by using a browser of the portable communication device 210. Moreover, the service end device 220 may instantly stores a portion of the translation text into the webpage when the service end device 220 finishes translating a portion of the text within the image corresponding to the portion of the translation text, such that the portable communication device 210 can instantly connect to the service end device 220 and browse the translation text from the webpage. The translation text can be inspected through the methods described above; however, the application of the present invention is not limited thereto.

Finally, in step S330, the portable communication device 210 displays the translation text on a screen (not shown) thereof so that the user can view and understand the meaning of the text within the originally captured image.

As described above, in the present invention, a complete recognition and translation mechanism in a service end device is adopted to instantly translate text within an image. Moreover, the service end device offers huge storage capacity and powerful calculation capability, such that recognition and translation of multiple languages can be completed, and even mega data text or irregularly edited text can be successfully recognized and translated. Furthermore, regarding complicated text, a translated portion can be instantly transmitted back to the portable communication device so that immediateness of translating function can be maintained. Accordingly, a user can take an image at any time and understand the meaning of the text within the image instantly. As a result, the portable communication device is made more entertaining to be used.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for instantly translating text within an image captured by a portable communication device, the method comprising:
the portable communication device capturing the image and transmitting the image to a service end device through a communication network;
the service end device recognizing and translating the text within the image into translation text and transmitting the translation text back to the portable communication device through the communication network; and
the portable communication device displaying the translation text.

2. The method according to claim 1, wherein the step of the service end device recognizing and translating the text within the image into the translation text and transmitting the translation text back to the portable communication device through the communication network comprises:
the service end device instantly transmitting a portion of the translation text back to the portable communication device when the service end device finishes translating a portion of the text within the image corresponding to the portion of the translation text.

3. The method according to claim 2, wherein the service end device instantly translates the portion of the text within the image and transmits the portion of the translation text back to the portable communication device if the image comprises irregularly-edited text or mega data text.

4. The method according to claim 1, wherein before the service end device transmits the translation text back to the portable communication device through the communication network, the method further comprises:
the portable communication device receiving a language translating request and transmitting the language translating request to the service end device through the communication network; and
the service end device translating the recognized text within the image according to the language translating request.

5. The method according to claim 1, wherein the step of the service end device transmitting the translation text back to the portable communication device through the communication network further comprises:
the service end device transmitting the translation text back to the portable communication device by using a short message.

6. The method according to claim 1, wherein the communication network comprises a global system for mobile communication (GSM), a code division multiple access (CDMA) system, or a personal handy-phone system (PHS).

7. A method for instantly translating text within an image captured by a portable communication device, the method comprising:
the portable communication device capturing the image and transmitting the image to a service end device through a communication network;
the service end device recognizing and translating the text within the image into translation text and storing the translation text into a webpage of the service end device; and
the portable communication device connecting to the service end device and browsing the translation text from the webpage by using a browser.

8. The method according to claim 7, wherein the step of the service end device recognizing and translating the text within the image into the translation text and storing the translation text into a webpage of the service end device comprises:
the service end device instantly storing a portion of the translation text into the webpage when the service end device finishes translating a portion of the text within the image corresponding to the portion of the translation text, for the portable communication device to instantly connect to the service end device and browse the translation text from the webpage.

9. The method according to claim 7, wherein the communication network comprises a global system for mobile communication (GSM), a code division multiple access (CDMA) system, or a personal handy-phone system (PHS).

10. A system for instantly translating text, comprising:
a portable communication device, comprising:
an image capturing unit, for capturing an image; and
a first communication module, for transmitting the image through a communication network; and
a service end device, comprising:
a second communication module, for receiving the image through the communication network;
a text recognition module, for recognizing the text within the image; and
a translation module, for translating the text within the image into translation text, wherein
after translating the text within the image into the translation text, the service end device transmits the translation text to the portable communication device through the second communication module.

11. The system according to claim 10, wherein the portable communication device further comprises:
an input interface, for receiving a language translating request, wherein the received language translating request is transmitted to the service end device through the first communication module and the service end device translates the text within the image according to the language translating request.

12. The system according to claim 10, wherein the service end device further comprises:
a multi-language database, for storing data of a plurality of languages, wherein the translation module translates the text within the image by referring to the multi-language database.

13. The system according to claim 10, wherein the text recognition module comprises an optical character recognition (OCR) module.

14. The system according to claim 10, wherein the portable communication device comprises a mobile phone, a personal digital assistant (PDA), or a smart phone.

15. The system according to claim 10, wherein the communication network comprises a GSM, a CDMA system, or a PHS.

16. The system according to claim 10, wherein the image capturing unit comprises a charge-coupled device (CCD) camera or a complementary metal oxide semiconductor (CMOS) camera.
